(19) United States
(12) Patent Application Publication
(10) Pub. No.: US 2014/0106189 A1
(43) Pub. Date: Apr. 17, 2014

(54) NON-AQUEOUS ELECTROLYTE SECONDARY BATTERY

(71) Applicants: Hideyo EBISUZAKI, Toyota-shi (JP); Masaru ISHII, Miyoshi-shi (JP); Hiroshi HAMAGUCHI, Toyota-shi (JP)

(72) Inventors: Hideyo EBISUZAKI, Toyota-shi (JP); Masaru ISHII, Miyoshi-shi (JP); Hiroshi HAMAGUCHI, Toyota-shi (JP)

(73) Assignee: TOYOTA JIDOSHA KABUSHIKI KAISHA, Toyota-shi (JP)

(21) Appl. No.: 14/041,704

(22) Filed: Sep. 30, 2013

(30) Foreign Application Priority Data
Oct. 16, 2012 (JP) 2012-229088

(51) Int. Cl. H01M 2/34

(52) U.S. Cl. CPC H01M 2/345
USPC 429/61

(57) ABSTRACT

A non-aqueous electrolyte secondary battery has a positive electrode, a negative electrode, a non-aqueous electrolyte solution containing a gas-forming additive, and a current interrupt device. The current interrupt device is configured to interrupt a current of the non-aqueous electrolyte secondary battery in response to a rise of internal pressure in the non-aqueous electrolyte secondary battery. The gas-foiming additive includes cyclohexylbenzene and at least one terphenyl selected from the group consisting of o-terphenyl and m-terphenyl.

### INCORPORATION BY REFERENCE

The disclosure of Japanese Patent Application No. 2012-229088 filed on Oct. 16, 2012 including the specification, drawings and abstract is incorporated herein by reference in its entirety.

### BACKGROUND OF THE INVENTION

1. Field of the Invention

The invention relates to a non-aqueous electrolyte secondary battery.

2. Description of Related Art

One technology for improving the safety of non-aqueous electrolyte secondary batteries (e.g., lithium ion secondary batteries) is the current interrupt device (CID). Generally, when a lithium ion secondary battery is overcharged, the electrolyte undergoes electrolysis, generating gases and heat. The CID is a mechanism which, by detecting the gases or heat generated during overcharging, stops charging of the lithium ion secondary battery. Japanese Patent Application Publication No. 2006-278106 (JP-2006-278106 A) describes a non-aqueous electrolyte secondary battery having a pressure-type CID, in which battery a terphenyl-containing gas-faulting agent has been added to the electrolyte.

The non-aqueous electrolyte secondary battery of JP-2006-278106 A has a high retention of capacity and also has a current interrupt function that operates when the battery is overcharged. However, because the gas-forming efficiency during overcharging is poor, a large amount of additive must be added to ensure the necessary amount of gas formation. In such cases, the battery performance may decrease during normal operation.

### SUMMARY OF THE INVENTION

The invention provides a non-aqueous electrolyte secondary battery which has excellent charge/discharge cycle characteristics and has a high current interrupt function during overcharging.

The non-aqueous electrolyte secondary battery according to one aspect of the invention has a positive electrode, a negative electrode, a non-aqueous electrolyte containing a gas-forming additive, and a current interrupt device. The current interrupt device is configured to interrupt a current of the non-aqueous electrolyte secondary battery in response to a rise of internal pressure in the non-aqueous electrolyte secondary battery. The gas-forming additive includes cyclohexylbenzene and at least one terphenyl selected from the group consisting of o-terphenyl and m-terphenyl.

The gas-forming additive may include from 0.5 to 2.0 parts by mass of the terphenyl per 2.0 parts by mass of cyclohexylbenzene. Alternatively, the gas-forming additive may include from 0.5 to 1.5 parts by mass of the terphenyl per 2.0 parts by mass of cyclohexylbenzene.

The non-aqueous electrolyte solution may include from 2.5 to 4.0 parts by mass of the gas-forming additive per 100 parts by mass of the non-aqueous electrolyte solution. Alternatively, the non-aqueous electrolyte solution may include from 2.5 to 3.5 parts by mass of the gas-forming additive per 100 parts by mass of the non-aqueous electrolyte solution.

The non-aqueous electrolyte solution may include 2 parts by mass of cyclohexylbenzene per 100 parts by mass of the non-aqueous electrolyte solution. The terphenyl may be m-terphenyl. The terphenyl may be o-terphenyl.

The aspect of the invention is able to provide a non-aqueous electrolyte secondary battery which has excellent charge/discharge cycle characteristics and has a high current interrupt function during overcharging.

### BRIEF DESCRIPTION OF THE DRAWING

Features, advantages, and the technical and industrial significance of exemplary embodiments of the invention will be described below with reference to the accompanying drawings, in which like numerals denote like elements, and wherein:

FIG. 1 is a structural diagram of a lithium ion secondary battery according to one embodiment of the invention.

### DETAILED DESCRIPTION OF EMBODIMENTS

The non-aqueous electrolyte secondary battery according to one embodiment of the invention (sometimes referred to below simply as the “battery”) is a lithium ion secondary battery 1. The lithium ion secondary battery 1 has a positive electrode 2, a negative electrode 3, a nonaqueous electrolyte solution containing a gas-forming additive, and a pressure-type CID 5. The pressure-type CID 5 is configured to interrupt a current of the lithium ion secondary battery 1 in response to a rise of internal pressure in the lithium ion secondary battery 1.

The positive electrode 2 is produced by stacking a positive electrode composition onto a positive electrode current collector. The positive electrode composition includes a positive electrode active material, a conductive material and a binder. The positive electrode active material is a material which is capable of the intercalation and deintercalation of lithium. For example, the positive electrode active material used may be lithium cobaltate (LiCoO₂), lithium manganate (LiMn₂O₄), or lithium nickelate (LiNiO₂). Alternatively, the positive electrode active material used may be a material obtained by mixing LiCoO₂, LiMn₂O₄ and LiNiO₂ in any proportions.

The positive electrode active material is not limited to these materials, and may be any material which is capable of the intercalation and deintercalation of lithium. The conductive material used may be a carbon black such as acetylene black (AB) or Ketjenblack®, or may be graphite.

The positive electrode composition may include a dispersant. Dispersants that may be used include polyvinyl acetal-type dispersants (binder-type dispersants). Illustrative examples of polyvinyl acetal-type dispersants include polyvinyl butyral, polyvinyl formal, polyvinyl acetoacetal, polyvinyl benzal, polyvinyl phenylacetal, and copolymers of these.

The binder used may be, for example, polyvinylidene fluoride (PVdF), styrene-butadiene rubber (SBR), polytetrafluoroethylene (PTFE) or carboxymethyl cellulose (CMC). The positive electrode current collector used may be a material which is made of aluminum or an alloy in which aluminum is the primary component.

In the fabrication of a positive electrode 2 according to this embodiment, first a positive electrode active material, a conductive material, a dispersant and a binder are compounded so as to give a positive electrode composition paste. It is preferable to use a solvent in order to adjust the solids content or viscosity of the positive electrode composition paste. The solvent used may be preferably N-methyl-2-pyrrolidone (NMP) or the like. Next, the positive electrode composition paste obtained after compounding is applied onto a positive electrode current collector and dried. The positive electrode 2 is then adjusted to a desired density by rolling.

The negative electrode active material is preferably a material capable of intercalating and deintercalating lithium. A carbon material in powder form constituted by graphite is especially preferred. The graphite is preferably coated with an amorphous material.

The negative electrode 3 is produced in a manner similar to the positive electrode 2 by stacking a negative electrode composition onto a negative electrode current collector. The negative electrode composition includes a negative electrode active material, a dispersant (solvent), a thickener and a binder. These materials are compounded to form a negative electrode composition paste. The negative electrode 3 can be produced by coating the negative electrode composition paste obtained after compounding onto a negative electrode current collector and drying.

The thickener is preferably the sodium salt of carboxymethyl cellulose (CMC). The binder is preferably styrene-butadiene rubber (SBR). The negative electrode current collector used may be, for example, copper, nickel, or an alloy thereof.

The non-aqueous electrolyte solution is a composition of a supporting salt contained within a non-aqueous medium. Here, the non-aqueous solvent may be one, two or more materials selected from the group consisting of propylene carbonate (PC), ethylene carbonate (EC), diethyl carbonate (DEC), dimethyl carbonate (DMC) and ethyl methyl carbonate (EMC). From the standpoint of increasing the battery power, the use of a three-component solvent system constituted by EC, DMC and EMC is preferred, and the use of a mixture having the volume ratio EC/DMC/EMC=30/40/30 is more preferred.

One, two or more lithium compound (lithium salt) selected from among LiPF₆, LiBF₄, LiClO₄, LiAsF₆, LiCF₃SO₃, LiC₄F₉SO₃, LiN(CF₃SO₂)₂, LiC(CF₃SO₂)₃, LiI and so on may be used as the supporting salt. From the standpoint of increasing the battery power, the use of LiPF₆ is preferred.

A gas-forming additive is added to the non-aqueous electrolyte solution of the lithium ion secondary battery 1 according to this embodiment. The gas-forming additive generates a gas by undergoing a decomposition reaction in the positive electrode 2 during overcharging. The gas-forming additive according to this embodiment includes cyclohexylbenzene (CHB; formula (1)) and at least one terphenyl selected from the group consisting of o-terphenyl (formula (2)) and m-terphenyl (formula (3)). It is possible to also mix, for example, biphenyl (BP) and/or p-terphenyl (formula (4)) into the gas-forming additive.

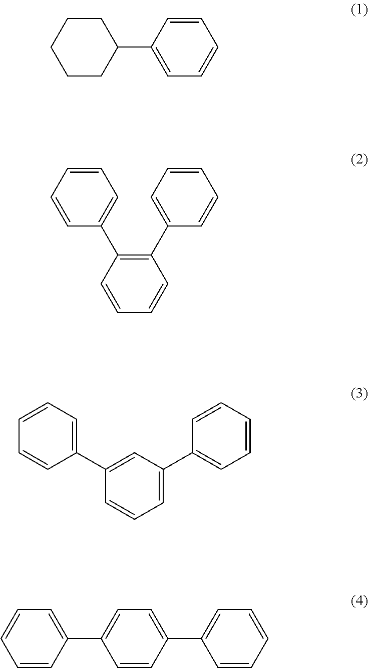

The gas-forming additive preferably includes cyclohexylbenzene and at least one terphenyl selected from the group consisting of o-terphenyl and m-terphenyl. The terphenyl may be constituted by o-terphenyl or m-terphenyl. By having the gas-forming additive include the above combination, the efficiency with which the gas required for current interruption is formed can be increased.

The gas-forming additive includes the above terphenyl in an amount of preferably 0.5 to 2.0 parts by mass, more preferably 0.5 to 1.5 parts by mass, and most preferably 0.5 to 1.0 part by mass, per 2.0 parts by mass of cyclohexylbenzene. The above composition does not necessarily indicate that the cyclohexylbenzene and terphenyl are limited to the foregoing ranges in parts by mass per 100 parts by mass of the non-aqueous electrolyte solution. However, by having the gas-forming additive possess the above composition, the efficiency with which the gas required for current interruption is formed can be further increased.

The non-aqueous electrolyte solution includes preferably from 2.5 to 4.0 parts by mass, more preferably from 2.5 to 3.5 parts by mass, and most preferably from 2.5 to 3.0 parts by mass, of the above gas-forming additive per 100 parts by mass of the non-aqueous electrolyte solution. By setting the total amount of addition of the gas-forming additive within the above range, the charge-discharge cycle characteristics can be increased while increasing the efficiency with which the gas required for current interruption is formed. In this embodiment, “increased charge-discharge cycle characteristics” means that the breadth of decrease in battery capacity after repeated charging and discharging becomes smaller.

The non-aqueous electrolyte solution of this embodiment preferably includes 2 parts by mass of cyclohexylbenzene per 100 parts by mass of the non-aqueous electrolyte solution. Moreover, the nonaqueous electrolyte solution of this embodiment includes preferably from 0.5 to 2.0 parts by mass, more preferably from 0.5 to 1.5 parts by mass, and most preferably from 0.5 to 1.0 part by mass, of the above terphenyl per 100 parts by mass of the non-aqueous electrolyte solution. Alternatively, the nonaqueous electrolyte solution of this embodiment includes preferably from 1.5 to 2.0 parts by mass, from 1.0 to 1.5 parts by mass, or from 0.5 to 1.0 part by mass of the above terphenyl per 100 parts by mass of the non-aqueous electrolyte solution.

Because the gas-forming additive has the above composition, the charge-discharge cycle characteristics can be increased while increasing the efficiency with which the gas required for current interruption is formed. However, the gas-founing additive is not limited to the above materials. Any material which increases the gas-forming efficiency without worsening the charge-discharge cycle characteristics may be added to the composition of the gas-forming additive.

The lithium ion secondary battery 1 according to this embodiment may have a separator 4. A porous polymer membrane such as a porous polyethylene (PE) membrane, a porous polypropylene (PP) membrane, a porous polyolefin membrane or a porous polyvinyl chloride membrane, or a lithium ion or ion-conductive polymer electrolyte membrane, may be used singly or in combination as the separator 4.

The CID 5 interrupts the current in response to the pressure of gas that has formed due to reaction of the gas-forming additive during overcharging. That is, the CID 5 stops charging of the lithium ion secondary battery 1 when the pressure at the interior of a lithium ion secondary battery 1 reaches or exceeds a given value due to gas that has formed during overcharging.

The CID 5 may be a device which, due to deformation of the lithium ion secondary battery 1 container when the internal pressure of the lithium ion secondary battery 1 rises, physically interrupts the path of the current fed to the lithium ion secondary battery 1. The device used for this purpose may be, for example, one which, with deformation of the lithium ion secondary battery 1 container, cuts the wiring that supplies current to the positive electrode 2 and/or the negative electrode 3 of the lithium ion secondary battery 1, and thereby stops charging.

Alternatively, the device may have a sensor which detects deformation of the lithium ion secondary battery 1 container and a circuit which stops charging depending on the results of measurement by the sensor, and may be configured so as to stop charging of the lithium ion secondary battery 1 when deformation of the container is detected by the sensor. Or the device may have a pressure sensor which detects the internal pressure of the lithium ion secondary battery 1 container and a circuit which stops charging depending on the results of measurement by the pressure sensor, and may be configured so as to stop charging of the lithium ion secondary battery 1 when the internal pressure of the container becomes equal to or greater than a given pressure.

The positive electrode 2, negative electrode 3, non-aqueous electrolyte solution and CID 5 produced as described above are assembled into a battery. The positive electrode 2 and negative electrode 3 produced as described above are stacked with a separator 4 therebetween, following which the resulting assembly is rendered into the form of a flattened coil (coiled electrode assembly). The coiled electrode assembly and the CID 5 are housed within a container having a shape capable of housing the coiled electrode assembly. The container has a container body that is open at the top end and a lid which closes the opening of the container body.

A metal material such as aluminum or steel may be used as the material making up the container. Also, a container obtained by molding a resin material such as polyphenylene sulfide resin (PPS) or polyimide resin may be used. The shape of the container may be cylindrical, but is not particularly limited. In cases where the battery is to be installed in an automobile, it may be rendered into large cells.

The lid serving as the top side of the container is provided with a positive electrode terminal and a negative electrode terminal. The positive electrode terminal electrically connects to the positive electrode 2 of the coiled electrode assembly. The negative electrode terminal electrically connects to the negative electrode 3 of the coiled electrode assembly. The above-described CID 5 may be integrally mounted on both electrode terminals. In addition, a non-aqueous electrolyte solution is contained in the container.

As explained in the subsequent examples of the invention, a gas-forming additive which contains cyclohexylbenzene alone or terphenyl alone has a relatively low gas-forming efficiency. In such cases, there is a possibility that increasing the amount of gas-forming additive so as to ensure the amount of gas needed to actuate the CID 5 will result in a decrease in the battery performance.

The gas-forming additive of this embodiment contains cyclohexylbenzene and at least one of o-terphenyl and m-terphenyl. Due to the synergistic effects of cyclohexylbenzene and o-terphenyl or m-terphenyl, the gas-forming additive of this embodiment has a higher gas-forming efficiency during overcharging than a gas-forming additive containing cyclohexylbenzene alone or terphenyl alone has. Hence, because the monomer polymerization reaction is promoted and gas forms efficiently, compared to cases in which use is made of a gas-forming additive containing cyclohexylbenzene alone or terphenyl alone, the CID 5 can be actuated during overcharging even when the gas-forming additive is added in a relatively small amount. Moreover, given that the gas-forming additive is added in a smaller amount, the charge-discharge cycle characteristics can be increased. This is explained in greater detail by verifying the effects in examples of the invention.

The battery of this embodiment may be installed in transportation equipment such as an electrical vehicle (EV) or a plug-in hybrid vehicle (PHV), and used as the power supply for driving the equipment. The invention is not limited to the above embodiment, and may be suitably modified within a range that does not depart from the gist of the invention as set forth in the attached claims.

Examples of manufactured batteries are described below. First, production of the positive electrode 2 is described. Letting 100 wt % represent the total amount of positive electrode composition, 91.0 wt % of LiNi_{1/3}Co_{1/3}Mn_{1/3}O₂ was used as the positive electrode active material, 6 wt % of carbon black was used as the conductive material, and 3 wt % of polyvinylidene fluoride (PVdF) was used as the binder.

The binder (PVdF) was added and mixed with N-methyl-2-pyrrolidone (NMP). Next, the carbon black was further added and compounding was carried out, thereby forming a positive electrode composition paste. Next, the positive electrode composition paste thus produced was applied to a basis mass of 32 mg/cm² onto a 15 μm thick aluminum foil as the positive electrode current collector. Following application, the positive electrode composition paste was dried at a temperature of 150° C. and an air flow speed of 5 m/sec. Finally, the paste was rolled with a rolling press, thereby adjusting the density.

Next, production of a negative electrode plate is described. Natural graphite powder, styrene-butadiene rubber (SBR) and carboxymethyl cellulose (CMC) were kneaded together with water in mass ratios therebetween of 98:1:1 to form a negative electrode composition paste. Next, this negative electrode composition paste was applied to a basis mass of 18 mg/cm² onto 10 μm thick copper foil (negative electrode current collector), then dried at a temperature of 150° C. and an air flow speed of 5 msec. Finally, the paste was rolled with a rolling press, thereby adjusting the density.

The non-aqueous electrolyte solution used was one prepared by including LiPF₆ as the supporting salt at a concentration of about 1.1 mol/L in a mixed solvent containing EC, EMC and DMC in a volume ratio of 3:3:4.

A gas-forming additive was added to the non-aqueous electrolyte solution. In the examples, CHB of formula (1) below was added as the first additive of the gas-forming additive, and o-terphenyl of formula (2) below or m-terphenyl of formula (3) below was added as the second additive.

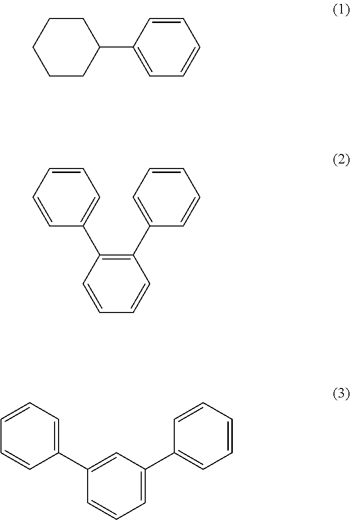

In Comparative Examples 4 and 5, p-terphenyl of formula (4) below was added as the second additive.

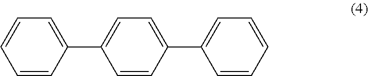 [SMILES: c1ccc(-c2ccc(-c3ccccc3)cc2)cc1]

Table 1 shows the compositions of the gas-forming additives in Examples 1 to 5 and Comparative Examples 1 to 5. In the table, the amounts of addition are shown in weight percent of gas-forming additive based on the gas-forming additive-containing non-aqueous electrolyte solution.

TABLE 1

| | First additive | Second additive | | | |
|---|---|---|---|---|---|
| | CHB | Terphenyl | | Capacity | Malfunction |
| | Amount added | | Amount added | retention | during |
| | (wt %) | Compound | (wt %) | (%) | overcharging |
| Example 1 | 2.0 | m-terphenyl | 2.0 | 82 | no |
| Example 2 | 2.0 | o-terphenyl | 2.0 | 81 | no |
| Example 3 | 2.0 | m-terphenyl | 1.5 | 85 | no |
| Example 4 | 2.0 | m-terphenyl | 1.0 | 86 | no |
| Example 5 | 2.0 | m-terphenyl | 0.5 | 86 | no |
| Comp. Ex. 1 | 4.0 | — | 0.0 | 79 | yes |
| Comp. Ex. 2 | 0.0 | o-terphenyl | 4.0 | 80 | yes |
| Comp. Ex. 3 | 0.0 | m-terphenyl | 4.0 | 81 | yes |
| Comp. Ex. 4 | 0.0 | p-terphenyl | 4.0 | 80 | yes |
| Comp. Ex. 5 | 2.0 | p-terphenyl | 2.0 | 79 | yes |

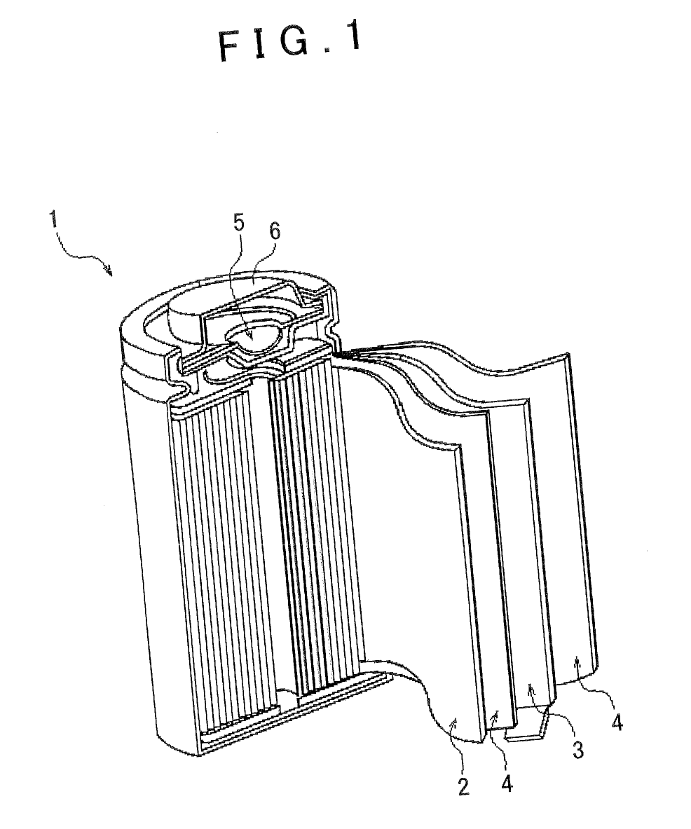

FIG. 1 is a structural diagram of a lithium ion secondary battery 1 according to an embodiment of the invention. The CID 5 was installed as follows. First, a diaphragm-shaped CID 5 formed of a metal foil was fabricated. The edge of the CID 5 was electrically connected to an external positive electrode terminal 6. In addition, the CID 5 was electrically connected near the center thereof to an internal positive electrode terminal. In FIG. 1, an internal positive electrode terminal may be thought of as being provided on top of the positive electrode 2.

As the state of charge (SOC) rises due to excessive charging of the battery, the gas-forming additive reacts, forming a gas. The battery had a construction such that, when the pressure within the housing formed of a battery case and a sealing member rises due to the gas that has faulted, the diaphragm-shaped CID 5 is pushed in at the sealing member side by the pressure. As a result, connection between the internal positive electrode terminal and the CID 5 is cut, electrically isolating the internal positive electrode terminal and the external positive electrode terminal 6.

The positive electrode 2 and the negative electrode 3 produced as described above were stacked together with two separators 4 therebetween. This assembly was then coiled, placed together with the non-aqueous electrolyte solution and the CID 5 in a cylindrical battery container, and the opening in the battery container was hermetically closed.

The capacity retention (%) measured as described below was used as an indicator for evaluating the charge-discharge cycle characteristics at elevated temperatures. Each battery was charged at a constant current of 1 C in a 60° C. thermostatic chamber. After the battery voltage reached 4.1 V, charging was carried out at a constant voltage of 4.1 V until the charging current became 1/10 C, thereby reaching a fully charged state. The battery was then discharged at a constant current of 1 C to a battery voltage of 3.0 V, the amount of charge that flowed during discharge was measured, and the discharge capacity was determined and treated as the initial battery capacity.

Next, similar charging and discharging was repeated for a total of 350 cycles. In the 350th cycle, the discharge capacity was measured in the same way and the value obtained was treated as the post-test battery capacity. The capacity retention (%) is the value obtained by dividing the post-test battery capacity by the initial battery capacity and multiplying the result by 100.

As shown in Table 1, the batteries in the examples of the invention which contained, based on the non-aqueous electrolyte solution, 2 wt % of CHB and from 0.5 to 2.0 wt % of o-terphenyl or m-terphenyl as the gas-forming additive tended to have a higher capacity retention than the batteries in the comparative examples. Also, in Examples 3 to 5 wherein the total amount of gas-forming additive added was less than 4 wt %, the capacity retention was higher than in Examples 1 and 2 and in all of the comparative examples. As the total amount of addition became lower, the capacity retention rose; the capacity retention was highest in Examples 4 and 5 in which the total amount of addition was from 2.5 to 3.0 wt %.

To evaluate the current interrupt performance during overcharging, testing and assessment were carried out as follows. Each battery was charged at 25° C. with a constant current of 1 C. After the battery voltage reached 4.1 V, the battery was charged at a constant voltage of 4.1 V until the charging current reached 1/10 C and was thereby placed in a fully charged state. Next, charging was continued at a constant current of 1 C. Batteries in which the CID 5 did not actuate because gas was not efficiently fottned, and which gave off smoke or ignited as a result were determined to have malfunctioned during overcharging.

As shown in Table 1, unlike in the comparative examples, no malfunctions during overcharging arose in the batteries of the examples of the invention which contained, based on the non-aqueous electrolyte solution, 2 wt % of CHB and from 0.5 to 2.0 wt % of o-terphenyl or m-terphenyl as the gas-forming additive.

The batteries according to the examples of the invention contained, based on the non-aqueous electrolyte solution, 2.0 wt % of CHB and from 0.5 to 2.0 wt % of o-terphenyl or m-terphenyl as the gas-forming additive. These batteries were found to have better charge-discharge cycle characteristics than the batteries in the comparative examples. Especially good charge-discharge cycle characteristics were obtained when the total amount of addition was lowered to 2.5 to 3.0%. Moreover, even when the total amount of addition in these batteries was smaller than 4 wt %, gas formed efficiently during overcharging. It was found also that the total amount of addition can be lowered to 2.5 wt %.

The above-described rise in battery performance is explained as follows. First, on comparing Example 1 with Comparative Examples 1 and 3, CHB and m-terphenyl exhibited synergism which led to the above-described effects that did not arise with either of these additives alone. The same was true also of o-terphenyl. As can be seen in above formula (1), CHB possesses within the cyclohexyl group hydrogens that easily react, and is thought to have a high gas-forming ability. At the same time, the cyclohexyl group and the phenyl group stochastically tend to assume a substantially identical planar structure, which is thought to limit the opportunities for collisions with other molecules.

In general, o- or m-terphenyl has a lower gas-forming ability than CHB. However, as shown in above formulas (2) and (3), not only do the three connected benzene rings have the same planar structure, the probability is high that there exists somewhat of an angle between the benzene rings on both ends in particular. For this reason, given that the above terphenyls are also able to adopt steric structures, the opportunities for collisions with other molecules appear to be increased. It is reasonable to surmise that synergistic effects are exhibited by combining the above two or more compounds.

The invention is not limited by the embodiments and examples described above, and encompasses various changes, modifications and combinations such as may be arrived at by those skilled in the art without departing from the scope of the invention.

What is claimed is:

1. A non-aqueous electrolyte secondary battery comprising:
a positive electrode;
a negative electrode;
a non-aqueous electrolyte solution containing a gas-forming additive; and
a current interrupt device configured to interrupt a current of the non-aqueous electrolyte secondary battery in response to a rise of internal pressure in the non-aqueous electrolyte secondary battery,
wherein the gas-forming additive includes cyclohexylbenzene and at least one terphenyl selected from the group consisting of o-terphenyl and m-terphenyl.

2. The non-aqueous electrolyte secondary battery according to claim 1, wherein the gas-forming additive includes from 0.5 to 2.0 parts by mass of the terphenyl per 2.0 parts by mass of cyclohexylbenzene.

3. The non-aqueous electrolyte secondary battery according to claim 2, wherein the gas-forming additive includes from 0.5 to 1.5 parts by mass of the terphenyl per 2.0 parts by mass of cyclohexylbenzene.

4. The non-aqueous electrolyte secondary battery according to claim 1, wherein the non-aqueous electrolyte solution includes from 2.5 to 4.0 parts by mass of the gas-forming additive per 100 parts by mass of the non-aqueous electrolyte solution.

5. The non-aqueous electrolyte secondary battery according to claim 3, wherein the non-aqueous electrolyte solution includes from 2.5 to 3.5 parts by mass of the gas-forming additive per 100 parts by mass of the non-aqueous electrolyte solution.

6. The non-aqueous electrolyte secondary battery according to claim 1, wherein the non-aqueous electrolyte solution includes 2 parts by mass of cyclohexylbenzene per 100 parts by mass of the non-aqueous electrolyte solution.

7. The non-aqueous electrolyte secondary battery according to claim 1, wherein the terphenyl is m-terphenyl.

8. The non-aqueous electrolyte secondary battery according to claim 1, wherein the terphenyl is o-terphenyl.

9. The non-aqueous electrolyte secondary battery according to claim 1, further comprising an external positive electrode terminal,
wherein the current interrupt device is configured so as to cut an electrical connection between the positive electrode and the external positive electrode terminal in response to the rise of internal pressure in the non-aqueous electrolyte secondary battery.
